(19) United States
(12) Patent Application Publication
(10) Pub. No.: US 2024/0387093 A1
(43) Pub. Date: Nov. 21, 2024

(54) PLANAR INDUCTOR WITH TUNABLE INDUCTANCE

(71) Applicant: Enphase Energy, Inc., Petaluma, CA (US)

(72) Inventors: Tyrone David LOW, Christchurch (NZ); Philip Mark HUNTER, Prebbleton (NZ)

(21) Appl. No.: 18/639,121

(22) Filed: Apr. 18, 2024

Related U.S. Application Data
(60) Provisional application No. 63/467,491, filed on May 18, 2023.

(51) Int. Cl. H01F 21/06; H01F 1/42; H01F 3/14

(52) U.S. Cl. CPC H01F 21/065; H01F 1/42; H01F 3/14

(57) ABSTRACT

The present disclosure provides a full inductor core configured for use with a power converter of an energy management system. For example, the full inductor core comprises a first planar inductor comprising a first inner core and a first outer core and a second planar inductor disposed on top of the first planar inductor and comprising a second inner core and a second outer core. The first inner core and first outer core and the second inner core and second outer core each have a sawtooth configuration that allows the full inductor core to be tuned during assembly of the full inductor core.

### CROSS-REFERENCE TO RELATED APPLICATIONS

The present application claims the benefit of and priority to U.S. Provisional Application Ser. No. 63/467,491, filed May 18, 2023, the entire contents of which is incorporated herein by reference.

### BACKGROUND

### Field of the Disclosure

Embodiments of the present disclosure relate generally to full inductor core and, more particularly, to full inductor cores that comprise planar inductors with tunable inductance.

### Description of the Related Art

Magnetic components in power electronic circuits (e.g., inverters) can have an air gap in a magnetic path which can be used to adjust an inductance value and, in conjunction with the number of turns of a coil, the air gap allows higher bias currents to be applied before the inductance (e.g., magnetic material) saturates. To contain magnetic fields (stray) originating from the air gap, the air gap is, typically, placed in a center pole of the component so that the component is surrounded by the coil, which is wound around the center pole. With planar magnetic components, and in particular, inductors, placing the air gap adjacent a broad surface of a planar coil can achieve better utilization of copper within the coil and lower effective AC resistance.

For example, conventional planar conductor configurations can comprise a concentric gap between an outer core and an inner core. The concentric gap provides a function of leakage inductance and can be positioned centrally above a printed circuit board (PCB) windings to minimize an effect of current crowding. A problem with conventional planar conductor configurations, however, is that tight manufacturing tolerances are required on the matching cylindrical faces that form the concentric gap. Part of the problem arises as a result of sintering tolerance on the final ferrite core sizes (e.g., typically +/−2% final size variation), which can equate to about +/−0.5 mm finished part size, for a 25 mm diameter shape. For example, a tolerance on the concentric gap width may need to be about +/−0.05 mm, which must include a machining tolerance of both faces, along with a placement or assembly tolerance. Achieving such tolerances is not feasible under conventional/practical manufacturing and assembly processes. For example, even with relatively expensive computerized numerical control (CNC) machining of each gapped surface, more reasonable tolerances that can be achieved is about +/−0.20 mm, which results in a large number of rejected parts when considering the final leakage inductance of the assembled product.

Accordingly, there is a need for improved full inductor cores that comprise planar inductors with tunable inductance.

### SUMMARY

Planar inductors with tunable inductance are provided herein. For example, in accordance with some aspects of the disclosure, a full inductor core configured for use with a power converter of an energy management system comprises a first planar inductor comprising a first inner core and a first outer core and a second planar inductor disposed on top of the first planar inductor and comprising a second inner core and a second outer core, wherein the first inner core and first outer core and the second inner core and second outer core each have a sawtooth configuration that allows the full inductor core to be tuned during assembly of the full inductor core.

In accordance with at least some aspects of the disclosure, an energy management system comprises a power source, a controller, and a power converter that comprises a full inductor core comprising a first planar inductor comprising a first inner core and a first outer core and a second planar inductor disposed on top of the first planar inductor and comprising a second inner core and a second outer core, wherein the first inner core and first outer core and the second inner core and second outer core each have a sawtooth configuration that allows the full inductor core to be tuned during assembly of the full inductor core.

In accordance with at least some aspects of the disclosure, a planar inductor core half configured for use with full inductor core comprises a first inner core and a first outer core configured to be connected to a second planar inductor core half, wherein the first inner core and first outer core each have a sawtooth configuration that allows the full inductor core to be tuned during assembly of the full inductor core.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a perspective view of a planar inductor, in accordance with one or more embodiments of the present disclosure;

FIG. 2 is top view of the planar inductor of FIG. 1, in accordance with one or more embodiments of the present disclosure; and

FIG. 3 is a block diagram of a system for power conversion using the inductor of FIG. 1, in accordance with one or more embodiments of the present disclosure.

### DETAILED DESCRIPTION

Embodiments of the present disclosure relate to full inductor cores that comprise planar inductors that are configured to be tuned to a particular value while following standard manufacturing processes. For example, a full inductor core configured for use with a power converter of an energy management system can comprise a first planar inductor core half comprising a first inner core and a first outer core and a second planar inductor core half disposed on top of the first planar inductor core half and comprising a second inner core and a second outer core. The first inner core and first outer core and the second inner core and second outer core each have a sawtooth configuration that allows the full inductor core to be tuned during assembly of the full inductor core. The planar inductors described herein allow for a high performance inductor design using standard ferrite core manufacturing techniques (e.g., pressing, sintering, face grinding, etc.). Additionally, the planar inductors described herein remove the requirement for an otherwise expensive CNC end grinding of the gapped faces on all 4 cores of the inductor. Hence, a cost of production of the planar inductors described herein is significantly reduced, and a viability of the planar inductor design is greatly improved. Moreover, the high performance capability of the planar inductor increases inverter efficiency.

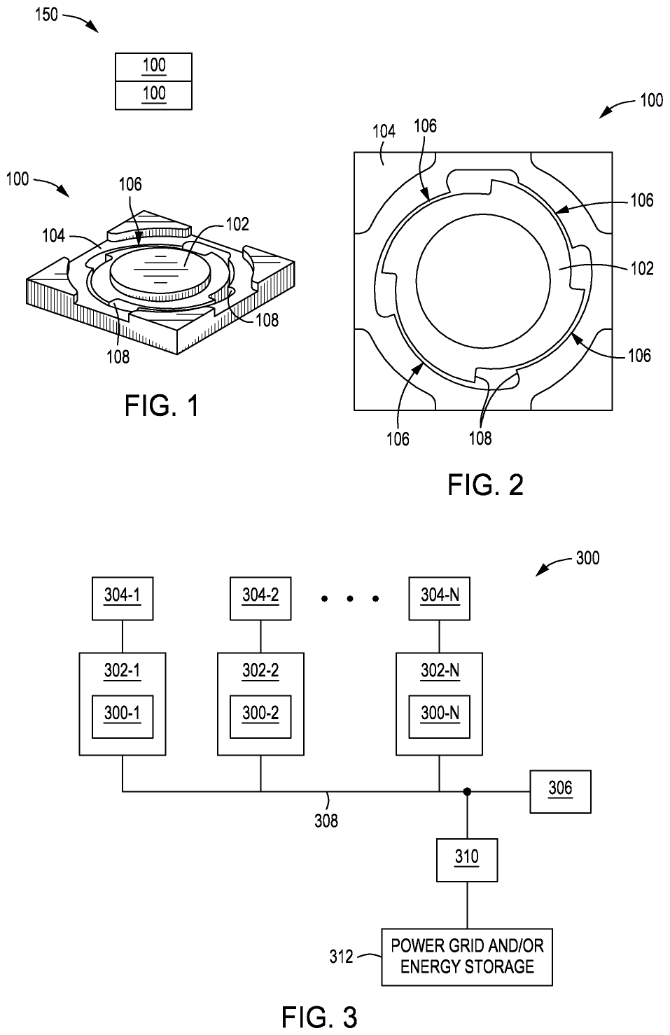

FIG. 1 is a perspective view of one half of a planar inductor core 100 and FIG. 2 is top view of the one half of the planar inductor core 100 of FIG. 1, in accordance with one or more embodiments of the present disclosure. In an assembled configuration, a full inductor core 150 can comprise two identical planar inductor core halves that are disposed on top of one another (e.g., a first planar inductor core half and a second planar inductor core half). In at least some embodiments, the full inductor core 150 can be configured to use copper layers of a PCB to form the inductor windings.

Unlike conventional inductor configurations (e.g., non-adjustable) which can require a very high degree of manufacturing tolerance to achieve the correct gap between the two parts of the core half, the planar inductors described herein include an adjustable gap (e.g., based on rotating a center part of a core half with respect to an outer part of the core half). For example, the planar inductor core 100 (which unlike conventional planar inductors is tunable) comprises an inner core 102 and an outer core 104 that have a sawtooth configuration that replaces a concentric circular air gap provided by the inner core and outer core of conventional planar inductors. The sawtooth configuration consists of spiral segments shaped to produce a uniform distance air gap (separation) despite rotation. In at least some embodiments, a profile of the sawtooth configuration follows an Archimedean spiral form so that the gapped surfaces remain parallel to each other following a shrinking that can sometimes occur during manufacture (e.g., during a sintering process).

In use, rotation of the inner core 102 (e.g., a center pole/sawtooth component) relative to the outer core 104 allows an air gap 106 (e.g., a predetermined air gap tolerance) distance to be adjusted (tuned, e.g., during assembly of the full inductor core) while maintaining a parallel air gap distance within the dominant magnet flux path of the inner core 102. For example, the inner core 102 can be moved during an assembly process and then fixed in place for the life of the product (e.g., the full inductor core 150). In at least some embodiments, the inner core 102 can be fixed in place using, for example, glue, tape, ratchet type assembly, etc. In at least some embodiments, the inner core 102 can be fixed in place using glue. A step 108 of the sawtooth configuration (which can be located on the sawtooth configuration of each of the inner core 102 and the outer core 104) occurs in the central region between outer return poles. The inventors note that the central region is not part of the dominant magnetic flux path.

Even with the +/−2% tolerance on finished part size (e.g., +/−1.0 mm on the air gap 106 size), the expensive CNC machining process can be avoided by simply rotating the inner core 102 clockwise or anti-clockwise to change the air gap 106 distance. In at least some embodiments, a required air gap size is about 0.65 mm +/−0.05 mm.

In at least some embodiments, a material with very low magnetic permeability can be used to provide a hard-stop for the air gap 106 to ensure that a +/−0.05 mm air gap tolerance is met. In at least some embodiments, a suitable material with very low magnetic permeability can comprise at least one of polymer or plastic. For example, in at least some embodiments one or more sheet materials (e.g., of material with very low magnetic permeability) can be used as a hard-stop material, and typically have a tolerance much lower than the +/−0.05 mm. In at least some embodiments, the one or more sheet materials can be a tape of the appropriate thickness. In such embodiments, the sheet of tape can be wound around the inner core 102 to provide a mechanical control on the size of the air gap 106 (e.g., between 102 and 104).

The inventors have found that a relatively square geometry in conjunction with the sawtooth configuration described herein provides that a majority of magnetic flux will flow towards the corners of the outer core 104. Therefore, any loss in gapped surface length in the N-S-W-E directions of the inner core is negligible.

FIG. 3 is a block diagram of a system 300 for power conversion (e.g., an energy management system) using the inductor of FIG. 1, in accordance with one or more embodiments of the present disclosure.

For example, the system 300 comprises a plurality of power converters 302-1, 302-2 . . . 302-N, collectively referred to as power converters 302 (e.g., power conditioners); a plurality of power sources 304-1, 304-2 . . . 304-N, collectively referred to as power sources 304; a controller 306; a bus 308; and a load center 310. The power sources 304 may be any suitable DC source, such as an output from a previous power conversion stage, a battery, a renewable energy source (e.g., a solar panel or photovoltaic (PV) module, a wind turbine, a hydroelectric system, or similar renewable energy source), or the like, for providing DC power. In some embodiments, the power converters 302 may be bidirectional converters and one or more of the power sources 304 is an energy storage/delivery device that stores energy generated by the power converter 302 and couples stored energy to the power converter 302.

Each power converter 302-1, 302-2 . . . 302-N is coupled to a power source 304-1, 304-2 . . . 304-N, respectively, in a one-to-one correspondence; in some alternative embodiments, multiple power sources 304 may be coupled to a power converter 302. The power converters 302-1, 302-2 . . . 302-N may be AC-AC converters that receive AC input and convert one type of AC power to another type of AC power. In other alternative embodiments, the power converters 302-1, 302-2 . . . 302-N may be DC-DC converters that convert one type of DC power to another type of DC power. In some of embodiments, the DC-DC converters may be coupled to a main DC-AC inverter for inverting the generated DC output to an AC output. The power converters 302 are coupled to the controller 306 via the bus 308.

The controller 306 is capable of communicating with the power converters 302 by wireless and/or wired communication (e.g., power line communication) for providing operative control of the power converters 302. In some embodiments, the controller 306 may be a gateway that receives data (e.g., performance data) from the power converters 302 and communicates the data and/or other information to a remote device or system, such as a master controller (not shown). Additionally or alternatively, the gateway may receive information from a remote device or system (not shown) and may communicate the information to the power converters 302 and/or use the information to generate control commands that are issued to the power converters 302. The power converters 302 are further coupled to the load center 310 via the bus 308.

The power converters 302 convert the DC power from the DC power sources to an AC output power and couple the generated output power to the load center 310 via the bus 308. The generated power may then be distributed for use, for example to one or more appliances, and/or the generated energy may be stored for later use, for example using batteries, heated water, hydro pumping, H₂O-to-hydrogen conversion, or the like. In some embodiments, the power converters 302 convert the DC input power to AC power that is commercial power grid compliant and couple the AC power to the commercial power grid via the load center 310. In some other embodiments, the power converters 302 may be AC:AC converters that receive an AC input; in still other embodiments, the power converters 302 may be AC:DC or DC:DC converters and the output power is a DC output power and the bus 308 is a DC bus.

In at least some embodiments, the load center 310 can connect to a storage system 312 configured for use with the system 300, such as the ENSEMBLE® energy management system available from ENPHASE®. For example, the storage system 312 can comprise an AC battery system. Alternatively, the storage system 312 can be a DC battery system with a corresponding battery and DC/DC power converters.

Each of the power converters 302 comprises a full inductor core 150 (i.e., the power converters 302-1, 302-2 . . . 302-N comprise the matrix planar full inductor core assemblies 300-1, 300-2 . . . 300-N, respectively) utilized in the conversion of the input power to the output power. In some embodiments, the power converters 302 are flyback converters. In other embodiments, the power converters 302 are resonant converters and the full inductor core 150 may comprise a corresponding flux shunt (not shown).

While the foregoing is directed to embodiments of the present disclosure, other and further embodiments of the disclosure may be devised without departing from the basic scope thereof, and the scope thereof is determined by the claims that follow.

What is claimed is:

1. A full inductor core configured for use with a power converter of an energy management system, comprising:
a first planar inductor core half comprising a first inner core and a first outer core and a second planar inductor core half disposed on top of the first planar inductor core half and comprising a second inner core and a second outer core,
wherein the first inner core and first outer core and the second inner core and second outer core each have a sawtooth configuration that allows the full inductor core to be tuned during assembly of the full inductor core.

2. The full inductor core of claim 1, wherein at least one of the first planar inductor core half or the second planar inductor core half comprises a material with very low magnetic permeability that is configured to ensure that a predetermined air gap tolerance is met between the first inner core and first outer core and the second inner core and second outer core.

3. The full inductor core of claim 2, wherein the material with very low magnetic permeability comprises at least one of polymer or plastic.

4. The full inductor core of claim 3, wherein the material with very low magnetic permeability is a sheet of tape that is wound around the first inner core or the second inner core.

5. The full inductor core of claim 2, wherein the predetermined air gap tolerance is about +/−0.05 mm.

6. The full inductor core of claim 1, wherein the first inner core is rotatable relative to the first outer core and the second inner core is rotatable relative to the second outer core such that an air gap distance between the first inner core and first outer core and an air gap distance between the second inner core and second outer core can be adjusted to tune the full inductor core while maintaining a parallel air gap distance within a dominant magnet flux path of the first inner core and the second outer core.

7. The full inductor core of claim 1, wherein the first outer core and the second outer core have a relatively square geometry that in conjunction with the sawtooth configuration provides that a majority of magnetic flux flows towards corners of first outer core and the second outer core.

8. An energy management system, comprising:
a power source;
a controller; and
a power converter comprising a full inductor core comprising:
a first planar inductor core half comprising a first inner core and a first outer core and a second planar inductor core half disposed on top of the first planar inductor core half and comprising a second inner core and a second outer core,
wherein the first inner core and first outer core and the second inner core and second outer core each have a sawtooth configuration that allows the full inductor core to be tuned during assembly of the full inductor core.

9. The energy management system of claim 8, wherein at least one of the first planar inductor core half or the second planar inductor core half comprises a material with very low magnetic permeability that is configured to ensure that a predetermined air gap tolerance is met between the first inner core and first outer core and the second inner core and second outer core.

10. The energy management system of claim 9, wherein the material with very low magnetic permeability comprises at least one of polymer or plastic.

11. The energy management system of claim 10, wherein the material with very low magnetic permeability is a sheet of tape that is wound around the first inner core or the second inner core.

12. The energy management system of claim 10, wherein the predetermined air gap tolerance is about +/−0.05 mm.

13. The energy management system of claim 8, wherein the first inner core is rotatable relative to the first outer core and the second inner core is rotatable relative to the second outer core such that an air gap distance between the first inner core and first outer core and an air gap distance between the second inner core and second outer core can be adjusted to tune the full inductor core while maintaining a parallel air gap distance within a dominant magnet flux path of the first inner core and the second outer core.

14. The energy management system of claim 8, wherein the first outer core and the second outer core have a relatively square geometry that in conjunction with the sawtooth configuration provides that a majority of magnetic flux flows towards corners of first outer core and the second outer core.

15. A planar inductor core half configured for use with full inductor core, comprising:
a first inner core and a first outer core configured to be connected to a second planar inductor core half,
wherein the first inner core and first outer core each have a sawtooth configuration that allows the full inductor core to be tuned during assembly of the full inductor core.
